(19) United States
(12) Patent Application Publication
(10) Pub. No.: US 2023/0378770 A1
(43) Pub. Date: Nov. 23, 2023

(54) CONFIGURABLE POWER SUPPLY SYSTEM

(71) Applicant: Our Next Energy, Inc., Novi, MI (US)

(72) Inventors: Mujeeb Ijaz, West Bloomfield, MI (US); Aaron C. Harkness, Howell, MI (US); John William Wagner, Ann Arbor, MI (US); Santhosh Abraham Jogi, Rochester, MI (US)

(21) Appl. No.: 18/125,993

(22) Filed: Mar. 24, 2023

Related U.S. Application Data
(60) Provisional application No. 63/269,967, filed on Mar. 25, 2022.

(51) Int. Cl. H02J 7/00; B60L 58/22; B60L 58/21

(52) U.S. Cl. CPC H02J 7/0014; B60L 58/22; B60L 58/21; H02J 2207/20; B60L 2210/10; B60L 2210/40

(57) ABSTRACT

A configurable power supply system that includes batteries, isolated bi-directional DC-DC converters, and contactors. Each battery has an isolated bi-directional DC-DC converter and contactors that are controlled in a sequence to pre-charge a DC-link capacitor and balance voltages of the batteries.

### CROSS-REFERENCE TO RELATED APPLICATIONS

This application claims priority to U.S. Provisional Application No. 63/269,967, filed on Mar. 25, 2022 and which is incorporated herein by reference in its entirety.

### TECHNICAL FIELD

The present invention relates generally to a power supply system. More particularly, the present invention relates to a configurable power supply system having one or more batteries configured to pre-charge and power a high voltage load.

### BACKGROUND

A system's power components may come from a variety of manufacturers. In a battery pack assembly, for example, a first battery with corresponding operational constraints, power outputs, and communication attributes may be obtained from one manufacturer, while a second battery with different operational constraints, power outputs, and communication attributes may be obtained from another manufacturer. Similarly, a motor's power input requirements, operational constraints, and/or communication attributes may differ significantly from the first and second batteries. As a result, said system's power electronics and control circuitry may have to be adjusted to accommodate differing operational constraints, power outputs, and communication attributes.

### SUMMARY

The illustrative embodiments disclose a configurable power supply system and a method for operating the configurable power supply system. In one aspect, the configurable power supply system includes a first battery and one or more second batteries adapted to precharge a DC-Link capacitor and power a high voltage load having the capacitor through operational modes performed by the control on one or more bi-directional DC-DC converters and contactors.

In another aspect, the configurable power supply system may have a parallel configuration wherein the batteries may be arranged in parallel with each other. In another aspect, the configurable power supply system may have a series configuration wherein the batteries may be arranged in series with each other. The bi-directional DC-DC converters may be isolated bi-directional DC-DC converters and may be electrically coupled in parallel with corresponding batteries and may be operable to charge or discharge the batteries by drawing or providing current to a high voltage bus.

In a further aspect, a method is disclosed. The method may comprise electrically coupling the first battery, having a first corresponding bi-directional DC-DC converter connected in parallel with the first battery, to a high voltage bus through a first corresponding bi-directional DC-DC converter or through a first corresponding contactor. The method further includes selectively electrically coupling, directly or indirectly, each of one or more second batteries to the high voltage bus, through second corresponding bi-directional DC-DC converters or through second corresponding contactors. The first battery and the one or more second batteries may each have the same or substantially the same nominal voltage.

The method may further include a predictive analytics process comprising receiving from the first and/or one or more second batteries measured power supply parameters for use by a trained machine learning model, and proposing, using the trained machine learning model, at least one power supply output characteristic for the configurable power supply system. Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced. Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings.

FIG. 1 depicts a block diagram of a power supply environment including a network of data processing systems in which illustrative embodiments may be implemented.

FIG. 2 depicts a block diagram of a data processing system in which illustrative embodiments may be implemented.

FIG. 3 depicts a drivetrain and energy storage components in accordance with illustrative embodiments.

FIG. 4 depicts a diagram of a configurable power supply system having a parallel arrangement in accordance with illustrative embodiments.

FIG. 5 depicts a diagram of a configurable power supply system having a parallel arrangement in accordance with illustrative embodiments.

FIG. 6 depicts a diagram of a configurable power supply system having a series arrangement in accordance with illustrative embodiments.

FIG. 7 depicts a process in accordance with illustrative embodiments.

FIG. 8 depicts a process in accordance with illustrative embodiments.

FIG. 9 depicts a process in accordance with illustrative embodiments.

FIG. 10 depicts a sequence in accordance with illustrative embodiments.

### DETAILED DESCRIPTION

The illustrative embodiments are directed to configurable power supply system having one or more batteries adapted to pre-charge and power a high voltage load. The illustrative embodiments recognize that on turning on a high-voltage system with downstream capacitance, it may be subjected to harmful inrush current which, if not controlled, may cause substantial stress or damage to system components. A pre-charge circuit with a pre-charge resistor and pre-charge contactor may be used to limit said inrush current. However, the illustrative embodiments recognize that a DC-DC converter may alternatively be used which may reduce costs, complexity and weight of the system.

Further, the illustrative embodiments recognize that to match the voltages and power levels of any new combination of interconnected power components, custom-designed power electronics or control-circuitry may be necessary. For example, in an electric vehicle the desired amount of power sent to the motor may be dependent on the combination of power batteries. New custom-designed power electronics and separate control circuits and/or separate pre-charging circuits may be required if a new motor or battery or other component is integrated into the system, a requirement that may be costly, bulky and time consuming.

The illustrative embodiments described herein are directed to a configurable power supply system comprising a first battery and one or more second batteries connected together in a parallel or series arrangement as described herein. By the configurable nature of the system, a high voltage bi-directional DC-DC drive current may be programmed to match an inverter bulk capacitance and achieve a target pre-charge time via the equation. i=C[(dV/dT), i.e., current flow onto a capacitor equals the product of the capacitance and the rate of change of the voltage. By the configurable nature, the system may also determine if the high voltage DC link is already at voltage (pre-charged by another battery brought online earlier) giving way for the performance of pack-to-pack balancing of the batteries/battery packs before closing main contactors. The bi-directional DC-DC converters may be isolated bi-directional DC-DC converters. However, this is not meant to be limiting and other bi-directional DC-DC converters are envisioned herein. A first corresponding bi-directional DC-DC converter may be electrically connected in parallel with said first battery, said first battery being selectively electrically coupled to a high voltage bus through the first corresponding bi-directional DC-DC converter or through a first corresponding contactor. The one or more second batteries may each have a second corresponding bi-directional DC-DC converter connected in parallel thereto, with each of the one or more second batteries being selectively electrically coupled, directly or indirectly, to the high voltage bus, through said second corresponding bi-directional DC-DC converter or through a second corresponding contactor. In these arrangements, the bi-directional DC-DC converters and the contactors may be operated temporally in a plurality of modes to pre-charge a DC-link capacitor of a high voltage load and power said high voltage load responsive to the pre-charging. The first battery and the one or more second batteries may have a same or substantially the same nominal voltage. This may provide the configurable power supply system with a modular structure that allows the building of power supply systems that meet varying specifications such that new control circuitry may not be necessary. Further, in a conventional pre-charge method, one may first close a main negative contactor. Then pre-charge may occur using the pre-charge contactor+pre-charge resistor. However, in some embodiments herein utilizing the bi-directional DC-DC converter, there may not be a need to first close the main negative contactor. If the BMS performs welded contactor checking prior to closing, some embodiments herein may allow for faster pre-charge relative to conventional methods.

In as aspect, operation of the batteries may be performed automatically by a controller of configurable power supply system 102 (e.g., local BMS (battery management system), master/supervisory BMS etc.) without input from an external controller. This may include automatic connection of batteries to high voltage bus, automatic check by a BMS for a welded contactor, automatic safety examination e.g., an ASIL-D (Automotive Safety Integrity Level) task of disconnecting a battery task that is performed by a pack level master BMS of the configurable power supply system 102 instead of by an external vehicle controller 130, and automatic monitoring and publishing of battery statistics (such as usable range).

The illustrative embodiments recognize that architectures and routines to control a plurality battery packs types under different criteria while meeting the power output and range requirements of a system such as an electric vehicle is a complex undertaking.

Certain operations are described as occurring at a certain component or location in an embodiment. Such locality of operations is not intended to be limiting on the illustrative embodiments. Any operation described herein as occurring at or performed by a particular component, e.g., operating a switching device, can be implemented in such a manner that one component-specific function causes an operation to occur or be performed at another component, e.g., at a local or remote system.

An embodiment may provide a method of operating a configurable power supply system. The method may comprise selectively electrically coupling a first battery, having a first corresponding bi-directional DC-DC converter connected in parallel with the first battery, to a high voltage bus through the first corresponding bi-directional DC-DC converter or through a first corresponding contactor. The method may further comprise selectively electrically coupling, directly or indirectly, each of one or more second batteries each having a second corresponding bi-directional DC-DC converter connected in parallel thereto to the high voltage bus, through said second corresponding bi-directional DC-DC converter or through a second corresponding contactor. In said method, the first battery and the one or more second batteries may be connected in parallel in a parallel arrangement or in series in a series arrangement, and in the parallel arrangement, the first battery and the one or more second batteries may have a same or substantially the same nominal voltage.

The illustrative embodiments are further described with respect to processes achieved using certain types of data, functions, equations, configurations, locations of embodiments, additional data, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific communications, code, designs, architectures, protocols, layouts, schematics, and tools only as examples and are not limiting to the illustrative embodiments. Furthermore, the illustrative embodiments are described in some instances using particular hardware, embedded software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the invention within the scope of the invention. An illustrative embodiment may be implemented in hardware, software, or a combination thereof.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

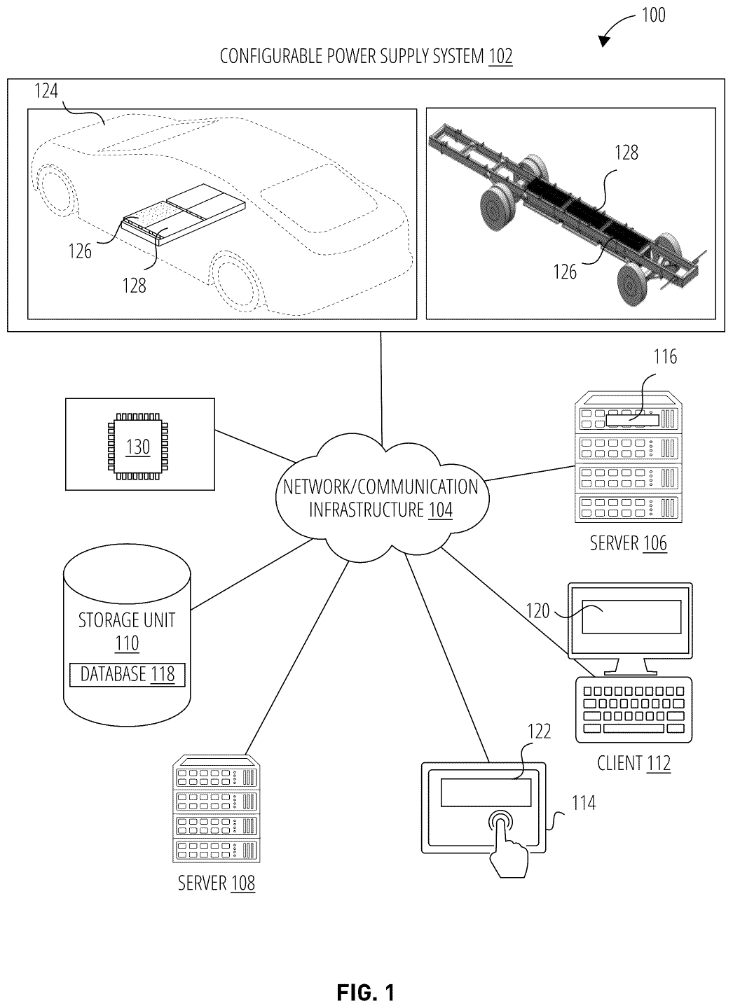

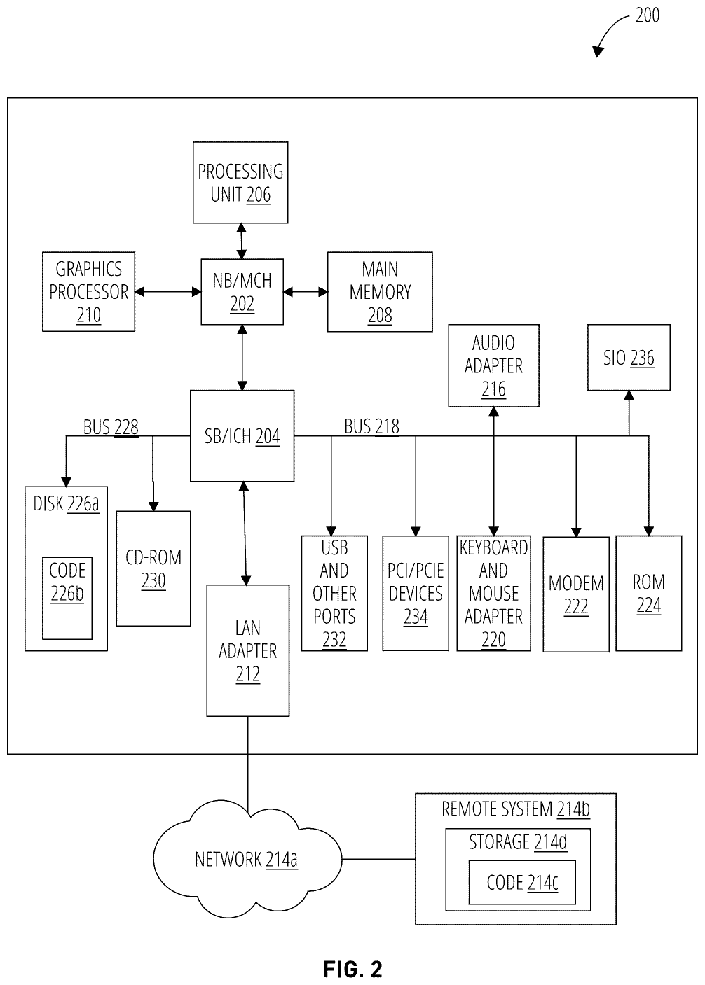

With reference to the figures and in particular with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a power supply environment 100 in which illustrative embodiments may be implemented. Power supply environment 100 may include configurable power supply system 102. It may also include network/communication infrastructure 104. Network/communication infrastructure 104 is the medium used to provide communications links between various devices such as the vehicle controller 130, databases and computers connected together within power supply environment 100. Network/communication infrastructure 104 may include connections, such as Controller Area Network (CAN) busses, wires, wireless communication links etc. In addition to the configurable power supply system 102, the environment may also include clients or servers configured to perform one or more processes herein. The configurable power supply system 102 includes a first battery 126 and at least a second battery 128 configured, for example, as battery packs. A dashboard 114 and a dashboard application 122 may be part or separate from configurable power supply system 102. The dashboard application 122 may be operable to control parameters of the configurable power supply system 102 including, for example, range requirement, startup of a vehicle of the configurable power supply system 102 etc.

Clients or servers are only example roles of certain data processing systems connected to network/communication infrastructure 104 and are not intended to exclude other configurations or roles for these data processing systems or to imply a limitation to a client-server architecture. Server 106 and server 108 couple to network/communication infrastructure 104 along with storage unit 110. Software applications, such as embedded software applications may execute on any computer or processor or controller in power supply environment 100. Client 112, dashboard 114 may also be coupled to network/communication infrastructure 104. Client 112 may be a remote computer with a display. A data processing system, such as server 106 or server 108, or clients (client 112, dashboard 114) may contain data and may have software applications or software tools executing thereon.

As another example, an embodiment can be distributed across several data processing systems and a data network as shown, whereas another embodiment can be implemented on a single data processing system within the scope of the illustrative embodiments. Data processing systems (server 106, server 108, client 112, dashboard 114) also represent example nodes in a cluster, partitions, and other configurations suitable for implementing an embodiment.

Client application 120, dashboard application 122, or any other application such as server application 116 may implement an embodiment described herein. Any of the applications can use data from configurable power supply system 102 or send instructions to configurable power supply system 102 and to partially or fully perform one or more processes described herein. The applications can also obtain data from storage unit 110 for power supply purposes. The applications can also execute in any of data processing systems (server 106 or server 108, client 112, dashboard 114).

Server 106, server 108, storage unit 110, client 112, dashboard 114, may couple to network/communication infrastructure 104 using wired connections, wireless communication protocols, or other suitable data connectivity. Client 112, and dashboard 114 may be, for example, mobile phones, personal computers or network computers.

In the depicted example, server 106 may provide data, such as boot files, operating system images, and applications to client 112, and dashboard 114. Client 112, and dashboard 114 may be clients to server 106 in this example. Client 112, and dashboard 114 or some combination thereof, may include their own data, boot files, operating system images, and applications. Power supply environment 100 may include additional servers, clients, and other devices that are not shown.

Network/communication infrastructure 104 may represent a collection of networks and gateways that use the Transmission Control Protocol/Internet Protocol (TCP/IP) and other protocols to communicate with one another. Of course, power supply environment 100 may also utilize a number of different types of networks, such as for example, a Controller Area Network, an intranet, a Local Area Network (LAN). FIG. 1 is intended as an example, and not as an architectural limitation for the different illustrative embodiments.

FIG. 2, depicts a block diagram of a data processing system in which illustrative embodiments may be implemented. Data processing system 200 is for example a computer, such as client 112, dashboard 114, server 106, or server 108, in FIG. 1, or another type of device in which computer usable program code or instructions implementing the processes may be located for the illustrative embodiments.

Data processing system 200 is described as a computer only as an example, without being limited thereto. Implementations in the form of other devices, may modify data processing system 200, such as by adding an additional interface, and even eliminating certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices.

Instructions for the operating system, and applications or programs, (such as server application 116, or client application 120 or dashboard application 122) are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. In addition, the processes of the illustrative embodiments may be applied to a multiprocessor data processing system.

A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 2 and above-described examples are not meant to imply architectural limitations.

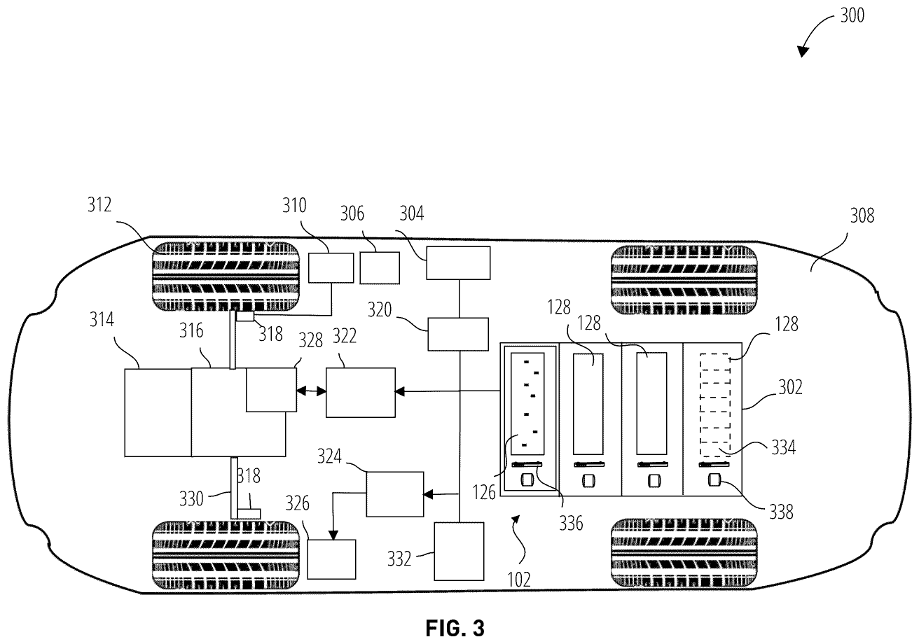

Turning to FIG. 3, a schematic of a generalized electric vehicle system 300 in which a configurable power supply system 102 may be housed will be described. It will become apparent to a person skilled in the relevant art(s) that the concepts described herein are directed configurable power supply systems 102 that may be in all electrified/electric vehicles, including, but not limited to, battery electric vehicles (BEV's), plug-in hybrid electric vehicles, motor vehicles, railed vehicles, watercraft, and aircraft configured to utilize rechargeable electric batteries as their main source of energy to power their drive systems propulsion or that possess an all-electric drivetrain. Said configurable power supply system 102 may also be used in any other electric/electrified systems that may store energy for use by a high voltage load having a DC-link capacitance.

The electric vehicle 308 may comprise one or more electric machine 328 mechanically connected to a transmission 316. The electric machine 328 may be capable of operating as a motor, for example. In addition, the transmission 316 may be mechanically connected to an engine 314, as in a PHEV. The transmission 316 may also be mechanically connected to a drive shaft 330 that is mechanically connected to the wheels 310. The electric machine 328 may provide propulsion and deceleration capability when the engine 314 is turned on or off. The electric machine 328 may also reduce vehicle emissions by allowing the engine 314 to operate at more efficient speeds and allowing the electric vehicle 308 to be operated in electric mode with the engine 314 off in the case of hybrid electric vehicles.

A battery pack assembly 302 of the configurable power supply system 102 may store energy that may be used by the electric machine 328. The battery pack assembly 302 may provide a high voltage DC output and is electrically connected to an inverter 322 having a DC-link capacitance, said inverter being configured to convert a DC input into a three-phase AC output to power said electric machine 328. In some embodiments, the battery pack assembly 302 comprises a traction battery and a range-extender battery. The configurable power supply system 102 may comprise the first battery 126 and one or more second batteries 128. Each battery/battery pack 126 and 128 may comprise a plurality of cells 334 which may be electrically coupled in series, for example, and each cell may be individually controllable, via a balancing device (e.g., Bleeder resistor) connected in parallel therewith. Moreover, by using a bi-directional DC-DC converter for each battery, the current input and output for each battery may be precisely controlled, unlike in load following solutions which have no control over changing drive power. Each battery may also have a cell-to-pack configuration wherein cells 334 may be directly placed in an enclosure of the battery pack with the enclosure also optionally housing other hardware such as, but not limited to the bi-directional DC-DC converter 336, system controller 306 (such as a battery management system (BMS)), battery thermal management system (cooling system and electric heaters) and contactors 338. Further, one or more sensors may be used to measure an operational state (such as a voltage, temperature, state of charge (SOC), state of health (SOH), etc.) of the battery pack and or of the individual cells where applicable. Each battery may have controllers such as the BMS that monitors and controls the performance of the battery. The BMS may monitor several battery pack level characteristics such as pack current, pack voltage and pack temperature. The BMS may have non-volatile memory such that data may be retained when the BMS is in an off condition.

One or more contactors 338 may isolate the battery pack assembly 302 from a high voltage bus when opened and connect the battery pack assembly 302 to the high voltage bus and other components such as the inverter 322 when closed. The inverter 322 is also electrically connected to the electric machine 328/motor and may provide the ability to bi-directionally transfer energy between the battery pack assembly 302 and the electric machine 328. For example, a battery may provide a DC voltage while the electric machine 328 may operate using a three-phase AC current. The inverter 322 may convert the DC voltage to a three-phase AC current for use by the electric machine 328. In a regenerative mode, the inverter 322 may convert the three-phase AC current from the electric machine 328 acting as generators to the DC voltage compatible with the battery pack assembly 302. The description herein is equally applicable to a BEV. For a BEV, the transmission 316 may be a gear box connected to the electric machine 328 and the engine 314 may not be present.

In addition to providing energy for propulsion, the battery pack assembly 302 may provide energy for other vehicle electrical systems. A typical system may include a DC/DC converter module 324 that may convert the high voltage DC output to a low voltage DC supply that is compatible with other vehicle loads. Other electrical loads 332, such as compressors and electric heaters, may be connected directly to the high voltage without the use of a DC/DC converter module 324. The low-voltage systems may be electrically connected to an auxiliary battery 326 (e.g., 116V battery). A power receiver 304 may be electrically connected to a charger or on-board power conversion module 326.

One or more wheel brakes 318 may be provided for decelerating the electric vehicle 308 and preventing motion of the electric vehicle 308. The wheel brakes 318 may be hydraulically actuated, electrically actuated, or some combination thereof. The wheel brakes 318 may be a part of a brake system 310. The brake system 310 may include other components to operate the wheel brakes 318.

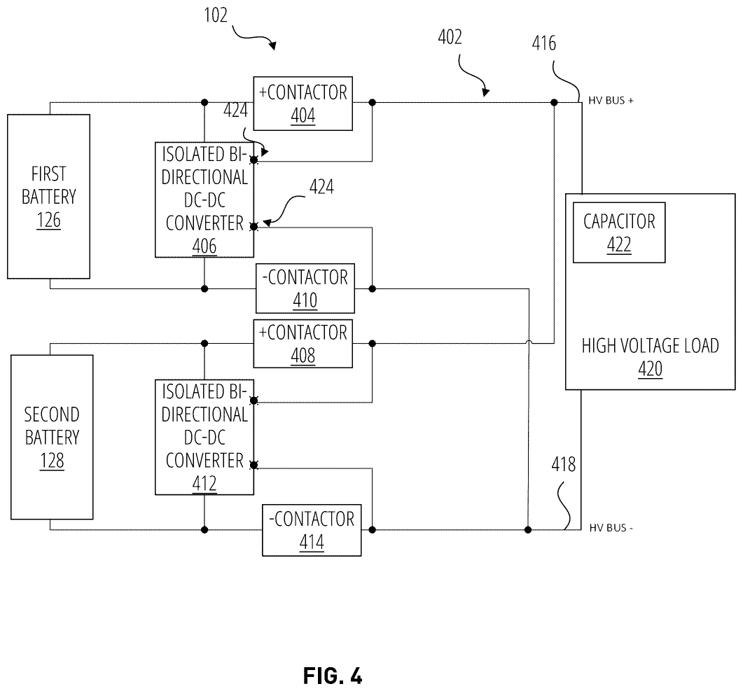

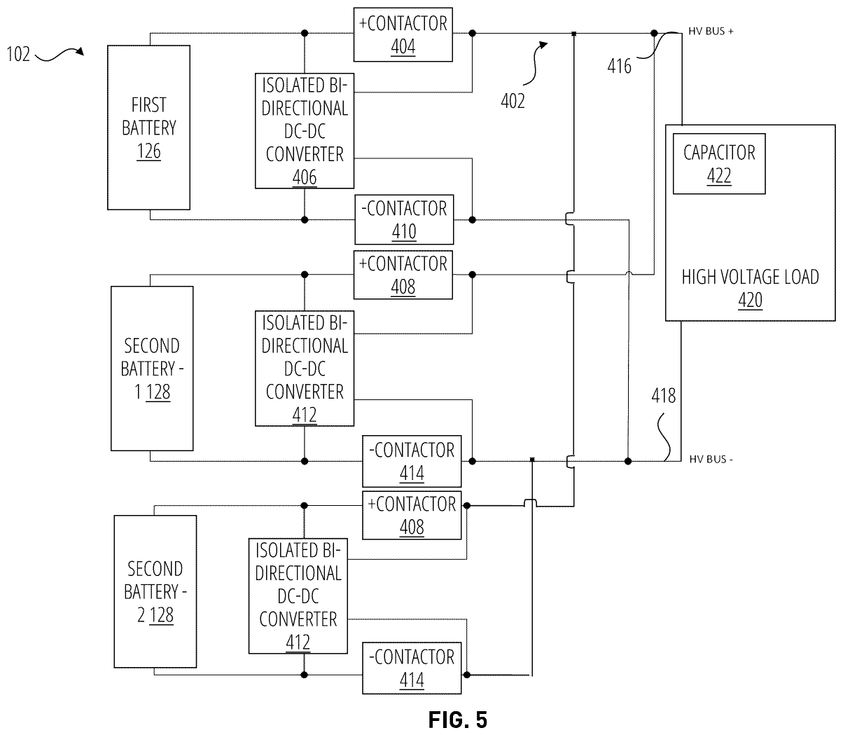

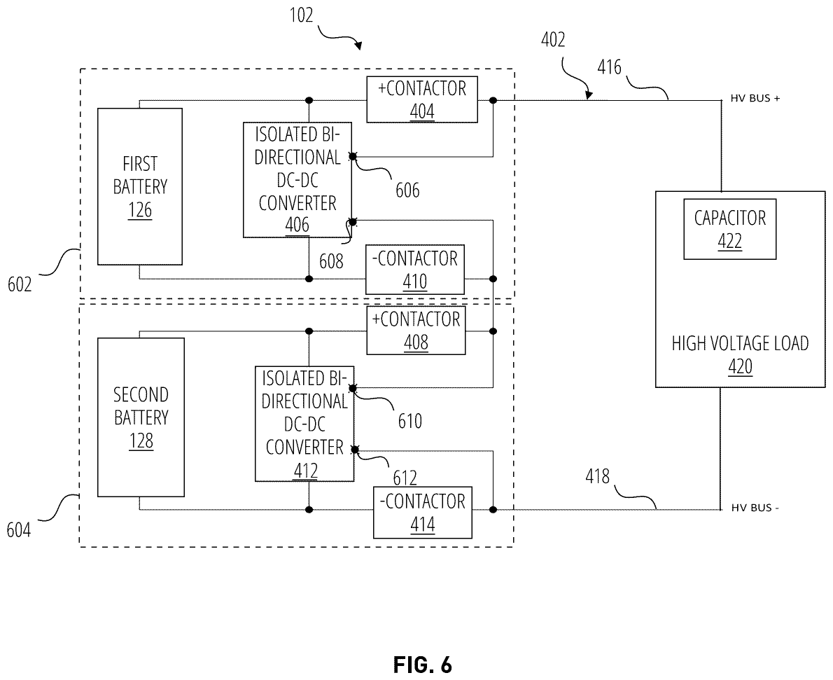

The configurable power supply system 102 may have a parallel arrangement as shown in FIG. 4 and FIG. 5 or a series arrangement as shown in FIG. 6. In both arrangements, the configurable power supply system 102 may include a first battery 126 having a first corresponding isolated bi-directional DC-DC converter 406 connected in parallel with the first battery 126, said first battery being selectively electrically coupled to the high voltage bus 402 through the first corresponding isolated bi-directional DC-DC converter 406 or through first corresponding contactors (first corresponding positive contactor 404, first corresponding negative contactor 410) depending on the operational mode, and one or more second batteries 128 each having a second corresponding isolated bi-directional DC-DC converter connected in parallel thereto and each being selectively electrically coupled, directly or indirectly (by way of the first battery electronics 602 as is in the case of the series arrangement), to the high voltage bus, through said second corresponding isolated bi-directional DC-DC converter or through a second corresponding contactor. The first battery 126 and the one or more second batteries 128 may have a same or substantially the same nominal voltage e.g., about 400V such as between 300-500V, or between 350-450V, or between 375-425V, or between 390-410V, or between 270-410V, each within 1%, or 5% or 10% or 20% of the nominal voltage. However, these ranges are not meant to be limiting as any other ranges may be obtained in view of the descriptions herein. In a series arrangement, the batteries may be connected to provide a high voltage bus voltage that is a sum of voltages of each battery, e.g., an HV DC voltage of about 800V.

In the configurable power supply system 102, the first and/or second isolated bi-directional DC-DC converters may each have a 1:1 voltage transform ratio and an output power of the first and/or second corresponding isolated bi-directional DC-DC converter may be about 6 kW (e.g., 6 kW+/−10% or +/−5%) with each having an isolated topology which uses a transformer. The configurable power supply system 102 may also be capable of being integrated into an existing electric vehicle driving system without a need to adjust a vehicle controller of the electric vehicle driving system. In the configurable power supply system 102, the voltages of the batteries may be equalized in a pack-to-pack balancing mode. Further, all operational modes such as pre-charging, pack-to-pack balancing, or continuous operation may be automatically performed through knowledge of information about a voltage of the DC bus.

With reference to FIG. 4, a configurable power supply system 102 having a parallel arrangement is shown. The configurable power supply system 102 comprises a high voltage bus 402, a first battery 126, a first corresponding positive contactor 404, a first corresponding negative contactor 410 and a first corresponding isolated bi-directional DC-DC converter 406. The configurable power supply system 102 also comprises a second battery 128, a second corresponding positive contactor 408, a second corresponding negative contactor 414 and a second corresponding isolated bi-directional DC-DC converter 412. The high voltage bus 402 may be configured as a positive high voltage bus 416 and a negative high voltage bus 418.

In the parallel arrangement, the first battery 126 may be configured to be electrically coupled to the high voltage bus 402 (positive high voltage bus 416 and negative high voltage bus 418) in a single battery pre-charging mode to pre-charge a DC-link capacitor of a high voltage load (e.g., An inverter) via the first corresponding isolated bi-directional DC-DC converter. Herein the first corresponding contactors (first corresponding positive contactor 404 and the first corresponding negative contactor 410) may be open. Subsequent to the pre-charging, the first battery may be electrically coupled to the high voltage bus 402 by closing the first corresponding contactors (404, 408) in a first operational mode to provide continuous power to the high voltage bus. However, assuming there is a need for a second battery 128, the first operational mode may be performed after a balancing of the first and second batteries. Herein, after the single battery pre-charging mode is complete, the second battery 128 may be configured to be electrically coupled to the high voltage bus 402 in a pack-to-pack balancing mode via a second corresponding isolated bi-directional DC-DC converter 412. In this pack-to-pack balancing mode, the second corresponding isolated bi-directional DC-DC converter 412 is operable to equalize voltages of the first battery 126 and of the second battery 128 through a draw or provision of current from the high voltage bus, depending on which battery has a lower or higher voltage respectively. Responsive to the completion of the pack-to-pack balancing mode (e.g., when voltages across the open contactor leads are brought to less than 4V), the second battery 128 may be electrically coupled to the high voltage bus 402 in a second operational mode, by closing the second contactors (second corresponding positive contactor 408 and second corresponding negative contactor 414) to provide continuous power to the high voltage bus. This may be performed at the same time as the first battery 126 is electrically coupled to the high voltage bus through closing of the first contactors, i.e., the first operational mode and the second operational mode may be performed together, after the pack-to-pack balancing mode, when there is more than one battery online. Thus, there may be no need for an adjustment in a vehicle controller 130 besides, for example, provision of information about a number available batteries depending on the application. Further, there may not be a need for pack-to-pack communication due to the ability to sense the voltages of the high voltage bus.

When one or more second batteries are activated, as shown in FIG. 5, the one or more second batteries 128 may each be configured to be electrically coupled to the high voltage bus in said pack-to-pack balancing mode to equalize (or substantially equalize, e.g. Within a few volts of each other, such as within 4 volts, or within 2 volts or within 1 volt, depending on contactor design and technology) the voltages of all connected batteries, subsequent to the single battery pre-charging mode, and via the second corresponding isolated bi-directional DC-DC converters 412. The one or more second batteries 128 may each further be configured to, responsive to completion of the pack-to-pack balancing mode, be electrically coupled to the high voltage bus in the second operational mode, to provide continuous power to the high voltage bus by closing their contactors as well as the contactors of the first battery 126. During the second operational mode, the high voltage bus may have a same voltage as the voltage of the first battery and of the one or more second batteries connected in parallel to the first battery. Thus, the first operational mode and the second operational mode may be performed together, responsive to completion of the pack-to-pack balancing mode.

With reference to FIG. 6, a series arrangement of the configurable power supply system 102 is shown. In said arrangement, the first battery 126 may be configured to be electrically coupled to the high voltage bus 402 (i.e., the positive high voltage bus 416 and the negative high voltage bus 418) via the first corresponding isolated bi-directional DC-DC converter 406 in a collective pre-charging mode with the one or more second batteries 128. Thus, the one or more second batteries 128 may each be configured to be connected in series with the first battery 126, via their respective isolated bi-directional DC-DC converters in said collective pre-charging mode, to collectively pre-charge the DC-link capacitor 422 of the high voltage load 420. This may involve initially turning on the first corresponding isolated bi-directional DC-DC converter 406 and detecting that a voltage of the high voltage bus is zero. The first corresponding isolated bi-directional DC-DC converter 406 may produce a voltage across its nodes (first positive node 606, second negative node 608) that matches the first battery voltage (e.g., −400V). The second corresponding isolated bi-directional DC-DC converter 412 may then also produce a voltage across its nodes (first positive node 610, second node negative 612) that matches the second battery voltage (e.g., −400V). This may produce a total voltage of −800V across the positive high voltage bus 416 and the negative high voltage bus 418 and pre-charge the capacitor 422. Generally, the sum of the voltage of the first battery and the one or more second batteries may add up to a total voltage of the high voltage load. The contactors 404, 410, 408, and 612 may be closed in a third operational mode to provide constant power to the high voltage load 420. In said third operational mode, the voltage of the high voltage bus may be a sum of the individual battery voltages. Likewise, the series arrangement may have one or more second batteries 128. However, as the voltage stresses on the individual pack's BMS becomes larger proper design may be needed to accommodate the higher voltages of the series stacked battery packs.

Thus, during the third operational mode, high voltage bus 402 may have a same voltage as a sum of the voltages of the first battery and of the one or more second batteries connected in series to the first battery. More specifically, said same voltage may be higher than a voltage of any individual battery of a total number(T) of connected batteries and said same voltage may provide a lower current for a same amount of required power and therefore a higher efficiency for the configurable power supply system relative to another efficiency of the configurable power supply system having a lower number (S) of connected batteries, where S<T, i.e., lowering current reduces wasted energy, or I²R losses).

In some embodiments herein, the configurable power supply system may optionally not have contactors for precharging. More specifically, by sizing the bi-directional DC-DC converter to be large enough to handle a power of the high voltage load, a need for the contactors may be eliminated and a separate precharging step may not be necessary. Thus, the high voltage load may be “charged” gradually by the bi-directional DC-DC converter to the maximum voltage due to the DC-DC converter being adapted to handle the power of the high voltage load.

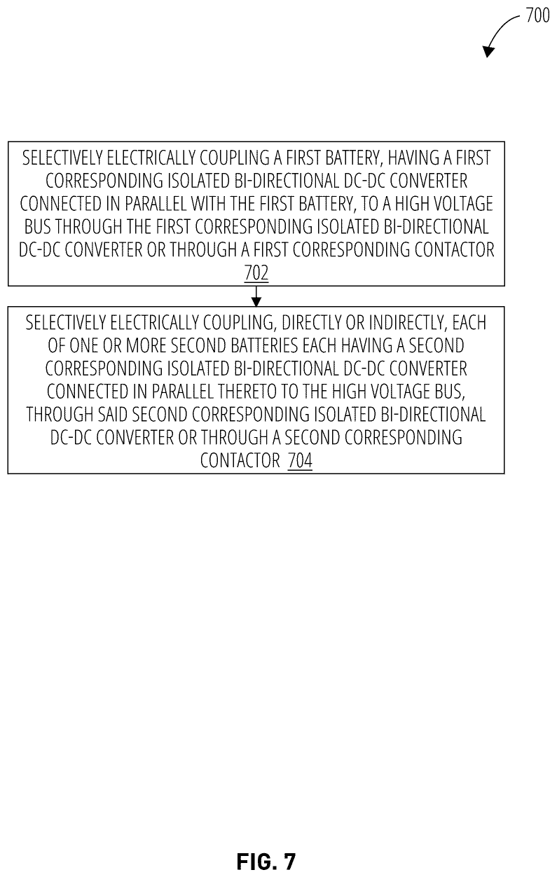

With reference to FIG. 7, a process 700 of operating the configurable power supply system 102 is described. In Step 702, process 700 selectively electrically couples the first battery, having a first corresponding isolated bi-directional DC-DC converter connected in parallel with the first battery, to a high voltage bus through the first corresponding isolated bi-directional DC-DC converter or through a first corresponding contactor.

In Step 704, process 700 selectively electrically couples, directly or indirectly (in the case of a series arrangement), each of one or more second batteries each having a second corresponding isolated bi-directional DC-DC converter connected in parallel thereto, to the high voltage bus, through the second corresponding isolated bi-directional DC-DC converter or through a second corresponding contactor. Said coupling of the first battery and the one or more second batteries is sequenced to pre-charges a DC link capacitor prior to closing main contactors of the batteries (and thus deactivating corresponding isolated bi-directional DC-DC converters) to provide power to the high voltage load. In process 700, the first battery and the one or more second batteries may be connected in parallel in a parallel arrangement or in series in a series arrangement and the first battery and the one or more second batteries may have a same or substantially the same nominal voltage. In process 700, each isolated bi-directional DC-DC converter may be operated to produce across its nodes (424, 606, 608) a voltage that matches the voltage of the corresponding battery to which it is connected in parallel and the isolated bi-directional DC-DC converters may no longer be needed upon closing of the contactors.

Process 700 may further include determining a voltage of the high voltage bus using the first or second corresponding isolated bi-directional DC-DC converter.

In an aspect, a master BMS may be used to automatically control or manage the batteries through, for example, the local BMS of each battery. The master BMS may alternatively be a pre-selected local BMS that controls, oversees or manages other local battery management systems. In the process, the master BMS, may automatically control one or more operations (e.g., Pre-charging, connecting battery packs, balancing, etc.) of the first battery and/or of the one or more second batteries at a pack level and provide information about a state of the first battery and/or the one or more second batteries through a pack level interface with the vehicle controller 130 or an external controller. Said state may include, for example, battery SOC (State of Charge), SOH (State of Health), SOE (State of Energy), SOP (State of Power), RM (Remaining Mileage) etc. Further, the master BMS may pack level battery balancing, battery temperature, battery protection, and battery diagnostics. By automatically managing and/or monitoring operations at a pack level without input from an external controller, information about the batteries may be readily available for external controllers through the pack level interface. The master BMS may also determine which packs are connected in the parallel or series arrangement based on one or more battery pack connection factors. This modular structure may provide several advantages including the ability to supply, through the pack level interface, a state of the battery or feedback for further remote or cloud processing. For example, a fleet of networked configurable power supply systems may be monitored and managed remotely based on said provided state information from each member of the fleet.

In an embodiment, master BMS controls other BMSs through pre-charging and connecting batteries based on received configuration information such as information received from vehicle control about a change in the required range, temperature, terrain, etc. and thus the master BMS may decide to bring another battery online.

Said state or feedback information may be used locally or remotely for a variety of predictive analytics. Any operation described herein as occurring at or performed by a particular component, e.g., a predictive analysis of battery data may be implemented in such a manner that one component-specific function causes an operation to occur or be performed at another component, e.g., at a local or remote machine learning (ML) engine respectively. An embodiment may monitor and manage the cumulative energy of one or more configurable power supply system 102. Another embodiment monitors the state of individual batteries of one or more configurable power supply system 102. Therefore, input data for the ML engine having an ML model may be determined directly from measurements obtained from components of the configurable power supply system 102 or power supply environment 100 and optionally from a user. The input data may include parameters such as pack current, temperature, voltage, impedance, state of health (SOH), state of charge (SOC), average energy consumption, and the like or otherwise subject configurable power supply parameters and user information such as a user's expressly stated preference for destination arrival time or a range goal during a specified period, speed, terrain, location, calendar etc. The input data as determined by an embodiment may be variable over time.

A machine learning engine may be provided to increase the resolution and efficacy of predictions made by a controller about refined human usable power supply output characteristics (such as total battery life, total range, power supply control recommendations, a likelihood of battery failure in a period of time, or other refined output parameter) based on a comparison of sensed and received information. The machine learning engine may detect patterns in the input data and weigh the probable vehicle energy and/or power supply operational outcomes based on these patterns. As a user engages with the configurable power supply system 102, data regarding the engagement (e.g., a trip) may be collected and stored for analysis by a local or remote controller or another network-connected computerized device. Data regarding engagements by multiple users in multiple configurable power supply systems 102 may be aggregated to allow additional resolution in detecting patterns and predicting behavior.

In another aspect an external controller such as the vehicle controller 130 may be configured to control operations of the batteries without the use of a master BMS.

In another aspect, process 700 comprises charging the first or one or more second batteries through the first or second corresponding isolated bi-directional DC-DC converter by drawing power from the high voltage bus. Herein, the step of balancing battery voltages, at least in the case of a parallel arrangement, is performed to equalize voltages of the first battery and of the one or more second batteries through a bi-directional flow of current. The isolated bi-directional DC-DC converter may equalize said voltages by discharging a higher voltage battery through drawing current from the high voltage bus and charging the lower voltage battery until the voltages are equal or substantially equal and vice versa. In another aspect, the first battery and the one or more second batteries may communicate with each other whereas in another aspect pack-to-pack communication may not be needed. Other technical features may be readily apparent to one skilled in the art from the following figures, descriptions, and claims.

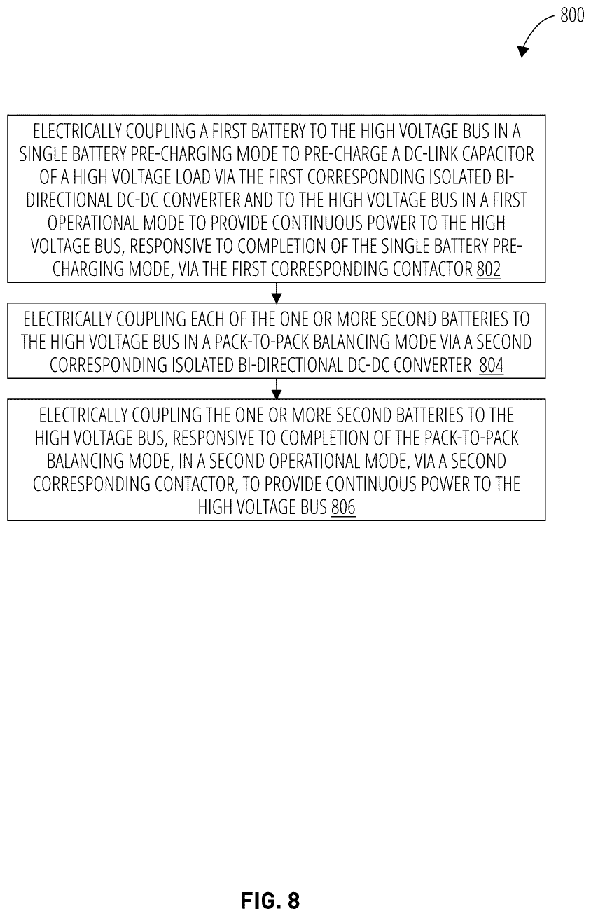

Turning now to FIG. 8 a process of operating a parallel arrangement of the configurable power supply system 102 is described. In Step 802, process 800 may electrically couple the first battery to the high voltage bus in a single battery pre-charging mode to pre-charge a DC-link capacitor of a high voltage load via the first corresponding isolated bi-directional DC-DC converter. Subsequently process 800 may electrically couple the first battery to the high voltage bus in a first operational mode to provide continuous power to the high voltage bus via the first corresponding contactor. In this case, the one or more second batteries are not connected yet. When the one or more second batteries are to be connected, Step 804, process 800 may electrically couple each of the one or more second batteries sequentially to the high voltage bus in a pack-to-pack balancing mode in which the voltages of the first and one or more second batteries are balanced via the second corresponding isolated bi-directional DC-DC converter. In Step 806, process 800 may electrically couple the one or more second batteries to the high voltage bus, responsive to completion of the pack-to-pack balancing mode, in a second operational mode, via a second corresponding contactor, to provide continuous power to the high voltage bus.

In the parallel arrangement, responsive to determining a safety issue with any of the batteries, the battery may be disconnected in an ASIL-D (Automotive Safety Integrity Level-D) step wherein the high voltage load/inverter may still be operable due to another battery in the parallel arrangement being available to continue providing power to the high voltage bus.

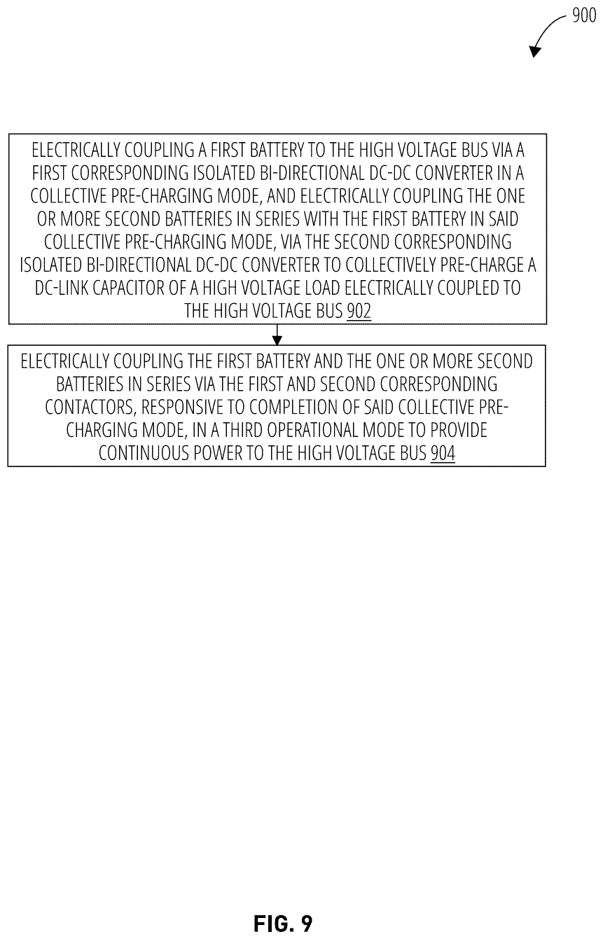

With reference to FIG. 9, a process 900 of operating a series arrangement of the configurable power supply system 102 is disclosed. In Step 902, process 900 determines that the DC-Link capacitor is not pre-charged and electrically couples the first battery to the high voltage bus via the first corresponding isolated bi-directional DC-DC converter in a collective pre-charging mode, and electrically couples the one or more second batteries in series with the first battery in said collective pre-charging mode, via the second corresponding isolated bi-directional DC-DC converter to collectively pre-charge a DC-link capacitor of a high voltage load electrically coupled to the high voltage bus. In Step 904, process 900 electrically couples the first battery and the one or more second batteries in series via the first and second corresponding contactors, responsive to completion of the collective pre-charging mode, in a third operational mode to provide continuous power to the high voltage bus. In the series arrangement of batteries, no balancing of battery packs may be needed. However, cells of the battery pack, which may be connected in series, may be balanced through balancing circuits such as bleeder resisters connected in parallel with each cell. Thus, when a cell (Cell A) is fully charged and a neighboring (cell B) is not fully charged, a balancing circuit of cell A may be activated to provide a bypass current flow for A. Cell A may therefore not be overcharged in the series configuration of cells.

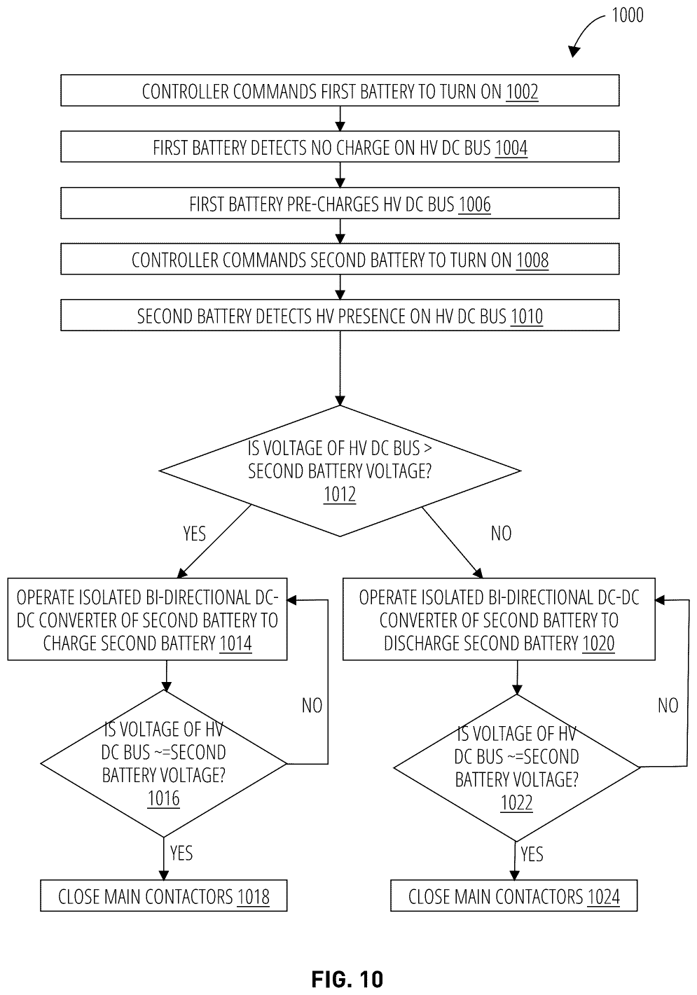

With reference to FIG. 10, a sequence 1000 of operating the first and one or more second batteries is shown. The sequence may begin at Step 1002 wherein a controller may command the first battery to turn on. In Step 1004, the first battery may detect no charge on the high voltage bus. In Step 1006, the first battery pre-charges the high voltage bus. In Step 1008, a controller commands the second battery to turn on. In Step 1010, the second battery detects a high voltage presence on the high voltage bus. In Step 1012, there is a determination of whether the voltage of high voltage bus is greater than the voltage of the second battery. In Step 1014, upon determining that the voltage of the high voltage bus is greater than a voltage of the second battery, the isolated bi-directional DC-DC converter of the second battery is operated to charge second battery until Step 1016 determines that the voltage difference between the voltage of the high voltage bus and the voltage of the second battery meets a defined stoppage criteria in which case charging is stopped and the main contactors are closed (Step 1018) to provide continuous power to the high voltage load. However in Step 1012, upon determining that the voltage of the high voltage bus is less than the voltage of the second battery, Step 1020 proceeds wherein the isolated bi-directional DC-DC converter of the second battery is operated to discharge the second battery until Step 1022 determines that the voltage difference between the voltage of the high voltage bus and the voltage of the second battery meets a defined stoppage criteria in which case the discharging is stopped and the main contactors are then closed (Step 1024) to provide continuous power to the high voltage load.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Where an embodiment is described as implemented in an application, the delivery of the application in a Platform as a Service (PaaS) and/or a Software as a Service (SaaS) model is contemplated within the scope of the illustrative embodiments.

Aspects of the present invention are described herein concerning flowchart illustrations and/or block diagrams of methods, apparatus (systems), and computer program products according to embodiments of the invention. It will be understood that computer readable program instructions can implement each block of the flowchart illustrations and/or block diagrams and combinations of blocks in the flowchart illustrations and/or block diagrams.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A configurable power supply system comprising:
a first battery having a first corresponding bi-directional DC-DC converter connected in parallel with the first battery, said first battery being selectively electrically coupled to a high voltage bus through the first corresponding bi-directional DC-DC converter or through a first corresponding contactor, and
one or more second batteries each having a second corresponding bi-directional DC-DC converter connected in parallel thereto and each being selectively electrically coupled, directly, or indirectly, to the high voltage bus, through said second corresponding bi-directional DC-DC converter or through a second corresponding contactor.

2. The configurable power supply of claim 1, wherein the first battery and the one or more second batteries are connected in parallel in a parallel arrangement or in series in a series arrangement, and
wherein the first battery and the one or more second batteries have a same or substantially the same nominal voltage.

3. The configurable power supply system of claim 1, wherein the configurable power supply system has said parallel arrangement, and
wherein the first battery is configured to be electrically coupled to the high voltage bus in a single battery pre-charging mode to pre-charge a DC-link capacitor of a high voltage load via the first corresponding bi-directional DC-DC converter and to the high voltage bus in a first operational mode to provide continuous power to the high voltage bus, responsive to completion of the single battery pre-charging mode, via the first corresponding contactor,
wherein the one or more second batteries are each configured to be electrically coupled to the high voltage bus in a pack-to-pack balancing mode via a second corresponding bi-directional DC-DC, converter, and
wherein the one or more second batteries are each further configured to, responsive to completion of the pack-to-pack balancing mode, be electrically coupled to the high voltage bus in a second operational mode, to provide continuous power to the high voltage bus via the second corresponding contactor.

4. The configurable power supply system of claim 3, wherein in said pack-to-pack balancing mode, the second corresponding bi-directional DC-DC converter is operable to equalize voltages of the first battery and of the one or more second batteries through a bi-directional flow of current from the high voltage bus.

5. The configurable power supply system of claim 3, wherein during the second operational mode, the high voltage bus has a same voltage as the voltage of the first battery and of the one or more second batteries connected in parallel to the first battery.

6. The configurable power supply system of claim 5, said same voltage is about 400V.

7. The configurable power supply system of claim 3, wherein the first operational mode and the second operational mode are performed together, responsive to completion of the pack-to-pack balancing mode.

8. The configurable power supply system of claim 1, wherein the configurable power supply system has said series arrangement, and
wherein the first battery is configured to be electrically coupled to the high voltage bus via the first corresponding bi-directional DC-DC converter in a collective pre-charging mode, and the one or more second batteries are each configured to be connected in series with the first battery in said collective pre-charging mode, via the second corresponding bi-directional DC-DC converter to collectively pre-charge a DC-link capacitor of a high voltage load electrically coupled to the high voltage bus, and
wherein the first battery and the one or more second batteries are further configured to, responsive to completion of said collective pre-charging mode, be connected in series via the first and second corresponding contactors in a third operational mode to provide continuous power to the high voltage bus.

9. The configurable power supply system of claim 8, wherein during the third operational mode, the high voltage bus has a same voltage as a sum of the voltages of the first battery and of the one or more second batteries connected in series to the first battery.

10. The configurable power supply system of claim 9, wherein said same voltage is higher than a voltage of any individual battery of a total number of connected batteries (T) and wherein said same voltage provides a lower current for a same amount of required power and therefore a higher efficiency for the configurable power supply system relative to another efficiency of the configurable power supply system having a lower number of connected batteries (S), wherein S<T.

11. The configurable power supply system of claim 9, wherein said voltages of the first battery and of the one or more second batteries connected in series to the first battery is about 400V.

12. The configurable power supply system of claim 9, wherein the one or more second batteries comprise only one second battery.

13. The configurable power supply system of claim 12, said same voltage is about 800V.

14. The configurable power supply system of claim 3, wherein the high voltage load is an inverter.

15. The configurable power supply system of claim 1, wherein the first battery and the one or more second batteries each have a cell-to-pack configuration.

16. The configurable power supply system of claim 1, wherein the first or second bi-directional DC-DC converter has a 1:1 voltage transform ratio.

17. The configurable power supply system of claim 1, wherein the configurable power supply system is capable of being integrated into an existing electric vehicle driving system without a need to adjust a vehicle controller of the electric vehicle driving system.

18. The configurable power supply system of claim 1, wherein the nominal voltage is a value between the range of 100V-1000V.

19. The configurable power supply system of claim 1, wherein an output power of the first and second corresponding bi-directional DC-DC converter is about 6 kW.

20. The configurable power supply system of claim 1, wherein the first corresponding contactor and the second corresponding contactor each comprises a pair of contactors including a positive contactor and a negative contactor.

21. A method comprising:
selectively electrically coupling a first battery, having a first corresponding bi-directional DC-DC converter connected in parallel with the first battery, to a high voltage bus through the first corresponding bi-directional DC-DC converter or through a first corresponding contactor, and
selectively electrically coupling, directly or indirectly, each of one or more second batteries each having a second corresponding bi-directional DC-DC converter connected in parallel thereto to the high voltage bus, through said second corresponding bi-directional DC-DC converter or through a second corresponding contactor;
wherein the first battery and the one or more second batteries are connected in parallel in a parallel arrangement or in series in a series arrangement, and
wherein the first battery and the one or more second batteries have a same or substantially the same nominal voltage.
a pack-to-pack balancing mode via a second corresponding bi-directional DC-DC converter, and
electrically coupling the one or more second batteries to the high voltage bus, responsive to completion of the pack-to-pack balancing mode, in a second operational mode, via a second corresponding contactor, to provide continuous power to the high voltage bus.
